(19) United States
(12) Patent Application Publication
(10) Pub. No.: US 2008/0005408 A1
(43) Pub. Date: Jan. 3, 2008

(54) Method and Apparatus for Increasing Transmission Efficiency of an Electronic Device using a Serial Peripheral Interface

(76) Inventors: Ting-Kuo Yen, Miao- Li Hsien (TW); Yung-Shin Wang, Hsinchu County (TW); Huang-Yuan Chen, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/424,238

(22) Filed: Jun. 15, 2006

(30) Foreign Application Priority Data
May 11, 2006 (TW) 095116698

(51) Int. Cl. G06F 3/00

(52) U.S. Cl. 710/58

(57) ABSTRACT

A method for increasing transmission efficiency of an electronic device using a serial peripheral interface includes receiving data from a first pin of the serial peripheral interface of the electronic device during a first duration according to a clock signal received from a clock pin of the serial peripheral interface of the electronic device, and outputting data from the first pin during a second duration according to the clock signal.

### BACKGROUND OF THE INVENTION

1. Field of the Invention

The present invention provides a method and apparatus for increasing transmission efficiency of an electronic device using a serial peripheral interface, and more particularly, a method and apparatus for receiving and outputting data through the same pin of the serial peripheral interface at different time, so as to increase transmission efficiency of the electronic device.

2. Description of the Prior Art

In an electronic device, transmitting data from one to another point can be performed by multiple data transmission methods. A common example is that a microprocessor or microcontroller transmits data to a memory device. The prior art data transmission methods can be classified into two types, serial and parallel data transmission methods. Transmission time of parallel data transmission is shorter than that of serial data transmission, but transmission wires of the parallel data transmission are more than that of the serial data transmission. Fewer transmission wires represents fewer pins of the microcontroller, so that the chip size of the microcontroller can be reduced. In addition, self-fault detection and debugging in the serial data transmission are simple so that an error unit can be easily tracked and replaced.

There are multiple mediums of the serial data transmission, such as a serial peripheral interface (SPI), an inter-IC bus, etc. The SPI is built up by Motorola and has been a standard serial peripheral interface in the art. The reason why the SPI is widely used is that as long as a chip designer provides a clock signal to an SPI of a chip, the chip can read and write data through the SPI according to the clock signal. Therefore, the SPI is useful for interfaces of communication systems, computers, computer peripherals, storage devices, consuming electronic products, and other devices not highlighted herein.

For example, please refer to FIG. 1, which illustrates a schematic diagram of a flash memory chip 10 having an SPI in the prior art. The flash memory chip 10 includes a power pin V_{CC}, a ground pin V_{SS}, a serial data output pin Q, a serial data input pin D, a clock pin C, a chip select pin S, a hold control pin HOLD, and a write protect pin W. The power pin V_{CC} and the ground pin V_{SS} are coupled to a system power source and ground respectively. The serial data output pin Q is utilized for outputting data from the flash memory chip 10. The serial data input pin D is utilized for receiving data for the flash memory chip 10. The clock pin C is utilized for receiving a clock signal, so as to provide operation timings for the SPI. The chip select pin S is utilized for indicating whether data is outputted from the chip select pin Q. When a level of a waveform received by the chip select pin S is high, the flash memory chip 10 is deselected, and the serial data output pin Q is in a high-impedance state. The hold control pin HOLD is utilized for indicating a temporary disconnection of the SPI of the flash memory chip 10. The write protect pin W is utilized for indicating whether a write function of the SPI is disable or not.

Controlling signal levels of the clock pin C, the chip select pin S, the hold control pin HOLD, and the write protect pin W, the flash memory chip 10 can receive data from the serial data input pin D and output data from the serial data output pin Q. For example, please refer to FIG. 2, which illustrates a timing diagram of the flash memory chip 10 when writing data. In FIG. 2, from top to bottom are waveforms of the clock pin C, the serial data input pin D, and the serial data output pin Q. When levels of waveforms received by the chip select pin S, the hold control pin HOLD, and the write protect pin W are low, the serial data input pin D is triggered by rising edges of the clock signal to receive data, and the serial data output pin Q is triggered by falling edges of the clock signal to output data.

Therefore, using the SPI, the prior art can control functions of data reception and output of the flash memory chip 10. However, since the flash memory chip 10 receives or outputs data in one way, operating speed of the flash memory chip 10 cannot be increased. That is, although transmission wires of the flash memory chip 10 are decreased, yet the SPI can only receive and output data in one way, which limits applications of the flash memory chip 10.

### SUMMARY OF THE INVENTION

It is therefore a primary objective of the claimed invention to provide a method and apparatus for increasing transmission efficiency of an electronic device using a serial peripheral interface.

The present invention discloses a method for increasing transmission efficiency of an electronic device using a serial peripheral interface. The method receives data from a first pin of the serial peripheral interface of the electronic device during a first duration according to a clock signal received from a clock pin of the serial peripheral interface of the electronic device, and outputs data from the first pin during a second duration according to the clock signal.

The present invention further discloses an electronic device using a serial peripheral interface. The electronic device includes a clock pin for receiving a clock signal, a first pin, and a control circuit for receiving data from the first pin during a first duration and outputting data from the first pin during a second duration according to the clock signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a flash memory chip having an SPI in the prior art.

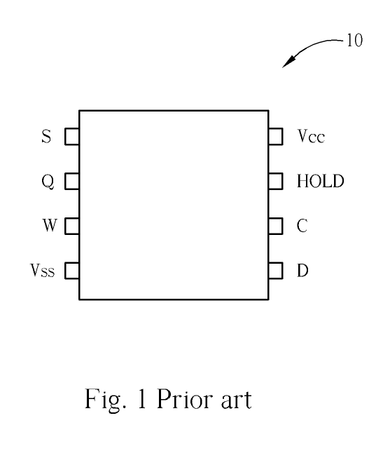

FIG. 2 illustrates a timing diagram of the flash memory chip shown in FIG. 1 when writing data.

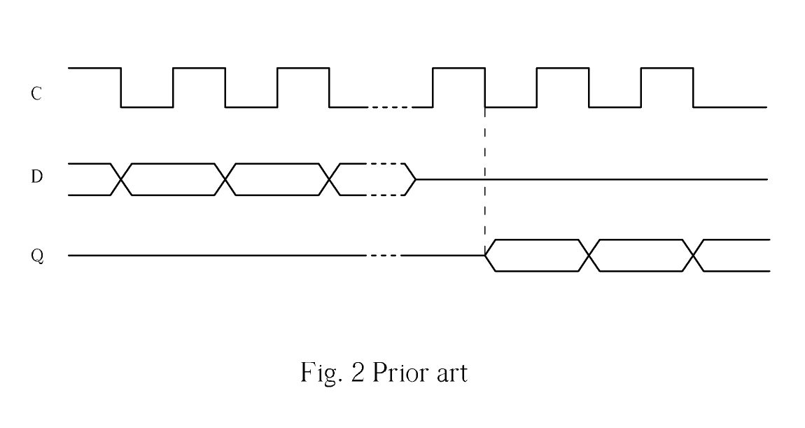

FIG. 3 illustrates a flowchart of a process in accordance with an embodiment of the present invention.

FIG. 4 illustrates a schematic diagram of a flash memory chip having an SPI in accordance with an embodiment of the present invention.

FIG. 5 illustrates a timing diagram of the flash memory chip shown in FIG. 4 when writing data.

### DETAILED DESCRIPTION

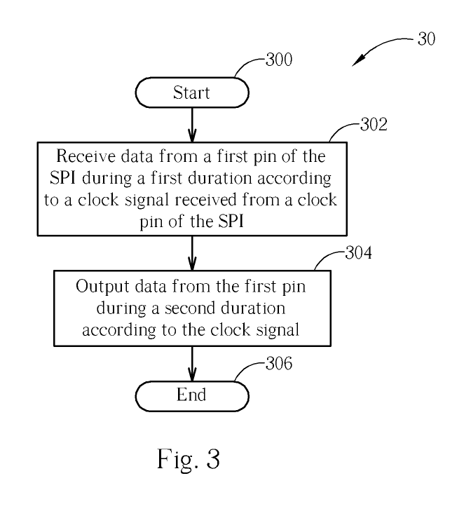

Please refer to FIG. 3, which illustrates a flowchart of a process 30 in accordance with an embodiment of the present invention. The process 30 is utilized for increasing transmission efficiency of an electronic device using an SPI, and includes following steps:

Step 300: start.

Step 302: receive data from a first pin of the SPI during a first duration according to a clock signal received from a clock pin of the SPI.

Step 304: output data from the first pin during a second duration according to the clock signal.

Step 306: end.

According to the process 30, the present invention can receive and output data through a pin of the SPI during different durations. That is, an identical pin can be used for receiving and outputting data at different time, so that transmission efficiency can be increased and wires can be decreased.

In the prior art, the SPI receives data through the serial data input pin and outputs data through the serial data output pin. In comparison, the present invention can uses the same pin of the SPI for receiving and outputting data at different time, so as to increase transmission efficiency.

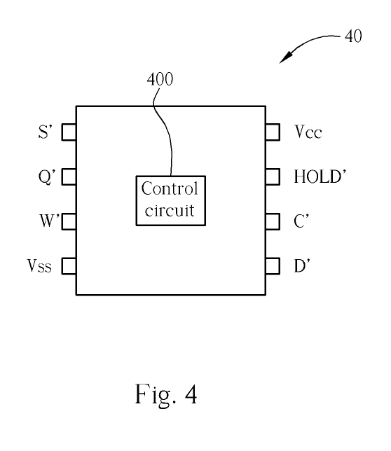

Please refer to FIG. 4, which illustrates a schematic diagram of a flash memory chip 40 having an SPI in accordance with an embodiment of the present invention. The flash memory chip 40 includes a control circuit 400, a power pin V_{CC}, a ground pin V_{SS}, a serial data output pin Q′, a serial data input pin D′, a clock pin C′, a chip select pin S′, a hold control pin HOLD′, and a write protect pin W′. The control circuit 400 is designed according to the process 30. According to a clock signal received by the clock pin C′, the control circuit 400 receives data from a specified pin of the pins during a first duration, and outputs data from the specified pin during a second duration. In the flash memory chip 40, the power pin V_{CC} and the ground pin V_{SS} are coupled to a system power source and ground, the clock pin C′ receives the clock signal, and the chip select pin S′ indicates whether the flash memory chip 40 is deselected or not. Therefore, the power pin V_{CC}, the ground pin V_{SS}, the clock pin C′, and the chip select pin S′ cannot be used for exchanging data, while the serial data output pin Q′, the serial data input pin D′, the hold control pin HOLD′, and the write protect pin W′ can be used for exchanging data.

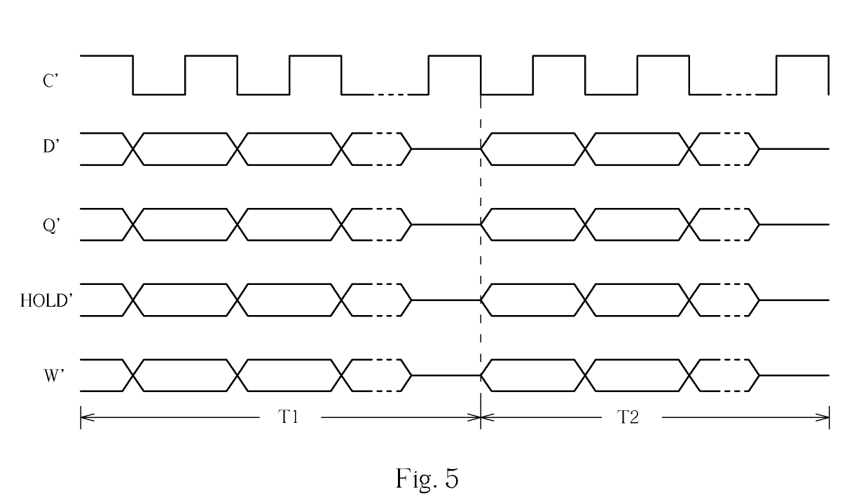

Please refer to FIG. 5, which illustrates a timing diagram of the flash memory chip 40 when writing data. In FIG. 5, from top to bottom are waveforms of the clock pin C′, the serial data input pin D′, the serial data output pin Q′, the hold control pin HOLD′, and the write protect pin W′. As shown in FIG. 5, during a duration T1, the flash memory chip 40 simultaneously receives data from the serial data input pin D′, the serial data output pin Q′, the hold control pin HOLD′, and the write protect pin W′, and during a duration T2 next to the duration T1, the flash memory chip 40 simultaneously outputs data from the serial data input pin D′, the serial data output pin Q′, the hold control pin HOLD′, and the write protect pin W′. Therefore, the efficiency and speed of data exchange in the flash memory chip 40 can be increased.

As mentioned above, the prior art SPI receives and outputs data in one way. Oppositely, the present invention can use an identical pin of the SPI to receive and output data in different time, so as to increase transmission efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for increasing transmission efficiency of an electronic device using a serial peripheral interface comprising:
receiving data from a first pin of the serial peripheral interface of the electronic device during a first duration according to a clock signal received from a clock pin of the serial peripheral interface of the electronic device; and
outputting data from the first pin during a second duration according to the clock signal.

2. The method of claim 1, wherein the first duration and the second duration are separated without overlapping.

3. The method of claim 1, wherein the first pin is a serial data input pin of the serial peripheral interface of the electronic device.

4. The method of claim 1, wherein the first pin is a serial data output pin of the serial peripheral interface of the electronic device.

5. The method of claim 1, wherein the first pin is a hold control pin of the serial peripheral interface of the electronic device.

6. The method of claim 1, wherein the first pin is a write protect pin of the serial peripheral interface of the electronic device.

7. An electronic device using a serial peripheral interface comprising:
a clock pin for receiving a clock signal;
a first pin; and
a control circuit for receiving data from the first pin during a first duration and outputting data from the first pin during a second duration according to the clock signal.

8. The electronic device of claim 7, wherein the first duration and the second duration are separated without overlapping.

9. The electronic device of claim 7, wherein the first pin is a serial data input pin of the serial peripheral interface of the electronic device.

10. The electronic device of claim 7, wherein the first pin is a serial data output pin of the serial peripheral interface of the electronic device.

11. The electronic device of claim 7, wherein the first pin is a hold control pin of the serial peripheral interface of the electronic device.

12. The electronic device of claim 7, wherein the first pin is a write protect pin of the serial peripheral interface of the electronic device.
